(19) United States
(12) Patent Application Publication
(10) Pub. No.: US 2020/0237596 A1
(43) Pub. Date: Jul. 30, 2020

(54) INFLATABLE BEDPAN

(71) Applicant: KATHY MUNN, SOUTH SHORE, KY (US)

(72) Inventor: KATHY MUNN, SOUTH SHORE, KY (US)

(21) Appl. No.: 16/262,399

(22) Filed: Jan. 30, 2019

(51) Int. Cl. A61G 9/00

(52) U.S. Cl. CPC A61G 9/003

(57) ABSTRACT

An inflatable bedpan that includes: an opening; a removable waste bag; a drawstring attached to the distal end of the removable waste bag; a hook and loop attachment for attaching the waste bag to the inner portion of the opening; a side opening to allow the removal of waste bag; an air input valve; and a bleed valve. The inflatable bedpan further includes a drawstring at the distal end of the waste bag and a flap to cover the side opening during none use.

### BACKGROUND OF THE INVENTION

### Field of Invention

The present invention relates to an inflatable bedpan that is used as a convenient replacement for the traditional bedpan.

### Description of Related Art

Numerous healthcare devices are used to assist in the care of patients. These healthcare devices include patient lifts, specialized beds, specialized wheelchairs, assistance with walkers, canes and other numerous devices. One kind of device used when a patient is bedridden is the traditional bedpan. A bedridden patient is typically incapable of moving or ambulating to a toilet or bathroom during a hospital stay. In these cases, a bedpan is used for the patient to release waste while lying in their bed. A traditional bedpan requires the rolling and maneuvering of the patient in order to place the pan under the patient's buttocks and to allow the patient to release waste. This process is quite cumbersome and inconvenient to a patient and further is troublesome for the medical care providers who must roll the patient and then also perform any cleanup associated with the use of bedpan. As a result, it would be advantageous to have a bedpan that remained in place under the patient but accommodated for removal and cleaning of the waste.

### SUMMARY OF THE INVENTION

The present invention relates to an inflatable bedpan that includes: an opening; a removable waste bag; a drawstring attached to the distal end of the removable waste bag; a hook and loop attachment for attaching the waste bag to the inner portion of the opening; a side opening to allow the removal of waste bag; an air input valve; and a bleed valve. The inflatable bedpan further includes a drawstring at the distal end of the waste bag and a flap to cover the side opening during none use.

### BRIEF DESCRIPTION OF DRAWINGS

FIG. 1 depicts an inflatable bedpan in accordance with the present invention.

### DETAILED DESCRIPTION

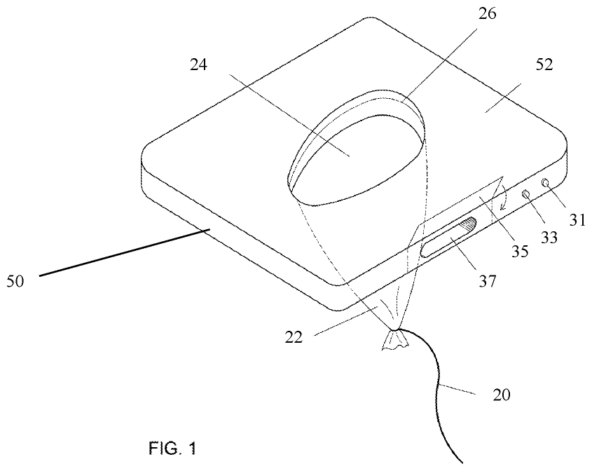

The present invention relates to an inflatable bedpan that includes a detachable waste bag and inflates as needed during use. The bedpan is deflated once use is complete. The bedpan helps to easily remove waste and then also alleviates the necessity of constant rolling and maneuvering of the patient for placement of a bedpan. A bedpan 50 according to the present invention is shown in FIG. 1. The bedpan 50 includes an opening 24 in a top surface 52. Attached to the opening 24 is a waste bag 22 as shown. The waste bag 22 is placed under the bedpan's opening 24 and attaches to the inner surface of the opening 24 by use of a bag attachment means 26. The bag attachment means 26 includes, in this particular instance, a hook and loop connection whereas the bag is placed securely along the inner rim of opening 24. The bag 22 also includes a drawstring 20 at the distal end thereof.

The bag 22 is drawn through a side opening 37 shown in FIG. 1. The side opening 37 with the assistance of drawstring 20 allows the removal of the bag 22 once the patient is finished with use thereof. A flap 35 normally covers the side opening 37 after the waste bag has been removed and replaced. The bag of the bedpan 50 includes an input valve 31 and a bleed valve 33. Air is injected through the input valve 31 to inflate bedpan 50 for use by the patient and once use is complete bleed valve 33 releases the air and deflates the bedpan 50.

Use of this bedpan provides a significant advantage over the traditional stationary bedpan of the prior art. The present invention also helps keeps a sanitary condition under the patient through the removal of the waste bag and the insertion of a new bag upon completion. Further the inflatable bedpan reduces the discomfort suffered by many patients through the use of a traditional bedpan.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An inflatable bedpan comprising:
an opening;
a removable waste bag;
a drawstring attached to the distal end of the removable waste bag;
a hook and loop attachment for attaching the waste bag to the inner portion of the opening;
a side opening to allow the removal of waste bag;
an air input valve; and
a bleed valve.

2. The inflatable bedpan according to claim 1 further including a drawstring at the distal end of the waste bag.

3. The inflatable bedpan according to claim 1, further including a flap to cover the side opening during none use.
